(19) United States
(12) Patent Application Publication
(10) Pub. No.: US 2026/0017689 A1
(43) Pub. Date: Jan. 15, 2026

(54) SYSTEMS AND METHODS FOR MARKETING CAMPAIGNS AND CREATING VERIFIED OPT-IN SUBSCRIBER REGISTRIES

(71) Applicants: Jay Conrad, Wagener, SC (US); William Beard, Olathe, KS (US); Edwin Hopkins, Monroe, MI (US); Peter Quinones, Miami, FL (US)

(72) Inventors: Jay Conrad, Wagener, SC (US); William Beard, Olathe, KS (US); Edwin Hopkins, Monroe, MI (US); Peter Quinones, Miami, FL (US)

(21) Appl. No.: 19/333,199

(22) Filed: Sep. 18, 2025

Related U.S. Application Data
(63) Continuation-in-part of application No. 19/292,693, filed on Aug. 6, 2025.
Application No. 19/292,693 is a continuation-in-part of application No. 17/368,150, filed on Jul. 6, 2021, now abandoned.
Application No. 17/368,150 is a continuation-in-part of application No. 15/684,926, filed on Aug. 23, 2017, now Pat. No. 11,055,744.
(60) Provisional application No. 62/378,461, filed on Aug. 23, 2016.
(60) Provisional application No. 63/696,489, filed on Sep. 19, 2024.

(51) Int. Cl. G06Q 30/0251

(52) U.S. Cl. CPC G06Q 30/0267

(57) ABSTRACT

A call to action sent through an electronic object is linked to a campaign platform having an executable program. When the call to action is activated, the executable program queries the device from which the call to action is activated, and collects data relating to the device. The collected data is added to information regarding an advertising campaign and incorporated into an outgoing message on the device. Once the outgoing message is sent, the information in the message is stored on a verified opt-in subscriber registry.

### CROSS-REFERENCE TO RELATED APPLICATIONS

This application is a Continuation-in-Part of Utility patent application Ser. No. 19/292,693 filed on Aug. 6, 2025, which is a Continuation-in-Part of Utility patent application Ser. No. 17/368,150 filed on Jul. 6, 2021, which is a Continuation-in-Part of 15/684,926 filed on Aug. 23, 2017, which claims the benefit of U.S. provisional patent application No. 62/378,461, which was filed on Aug. 23, 2016. The application also claims the benefit of U.S. provisional patent application No. 63/696,489.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Portions of the disclosure of this patent document contains material which is subject to copyright protection. The copyright owner has no objection to the facsimile reproduction by anyone of the patent document or the patent disclosure after formal publication by the U.S. Patent Office, as it appears in the U.S. Patent and Trademark Office patent file or records, but otherwise reserves all copyright rights whatsoever. VorTxT©2024

### BACKGROUND OF THE INVENTION

### Field of the Invention

The present invention relates to a systems and methods for creating a verified opt-in Registry for SMS marketing campaign. More particularly, the invention relates to systems and methods for creating a verified opt-in registry using a call to action prompt that collects data from a device and incorporates that data into an SMS message generated by the call to action prompt, and storing the collected data in a registry.

### Description of the Related Art

As cellular phones and smartphones have become ubiquitous, text, or SMS, messaging has become a common means of communication. Text messaging systems have also become very popular for marketing purposes. Telephone numbers for existing and prospective customers and clients have become valuable assets to companies wishing to promote their brands. Methods of acquiring telephone numbers for a particular SMS advertising campaign have become increasingly more sophisticated, allowing for more precisely directed advertising, and thus improving the quality of the marketing campaign itself.

Unfortunately, “spam” text messaging has grown at least as quickly as the use of messaging services. Less scrupulous companies bombard consumers with unwanted messages. Adding to this problem, unsolicited messaging may also include malware. Laws now protect consumers in many ways. For example, any owner of a cellular phone number may opt out of receiving messages. Various other regulations control what marketing materials may be sent via messaging software to what type of consumers. As a result of these regulations, a marketing campaign must be able to verify that the phone numbers to which SMS messages are being sent have consented to receive these messages. While this is a great benefit to consumers, it can be problematic for advertisers. Consumers do not always remember which messages they have consented to. As a result, they can and do often flag legitimate SMS advertising.

Once a message has been flagged by a consumer, the advertiser must cease all further messaging unless it can establish that the SMS messages were voluntarily agreed to by the consumer. If a customer has an existing account or profile with the advertiser, then consent can be established fairly easily. However, companies often wish to market to potential customers that have not yet gone to the trouble of creating an account on a company's website. In this situation, it is very difficult to prove that consent was ever given. This is because consumers usually opt-in to an advertising campaign by simply clicking on a call to action (“CTA”) on a website, email, or QR code or other CTA. Typically, the CTA only generates a message on a device to a phone number associated with an advertising campaign. When a message is flagged, the advertiser generally cannot readily establish consent.

The process for initiating an SMS messaging campaign can be complicated. Carriers to not wish to grant access to their system unless they are assured that the campaign is legitimate. To simplify the process for a Mobile Network Operator (MNO) to approve an Application to Person (A2P) SMS campaign, The Campaign Registry (TCR) was created. Direct Connect Aggregators (DCA's) and Communication Service Providers (CSP's) register their clients' campaigns on TCR so that network providers can use it to verify campaigns. Unfortunately, when a network provider receives a complaint regarding a campaign, the information on TCR is not sufficient to perform a full audit. Therefore, regardless of whether a campaign is on TCR, it will typically be shut down by a network operator until the campaign can be more fully audited and verification of the mobile numbers in the campaign explicitly established. This effectively shuts down the entire campaign indefinitely. This is an ongoing and substantial problem for digital advertisers.

TCR initial brought hope from many that there would be a new standard which would create a reliable place that would help support their messaging campaigns. But ultimately, it had no impact on the relationship between compliance and ongoing success. The TCR quickly became a placeholder for information after a campaign approval, not a tol for enforcement or compliance.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide systems and methods for rapidly verifying that a particular text messaging marketing campaign has been approved for all cellular phone numbers in the campaign. It is also desirable to provide a registry of approved phone numbers that includes the information required to verify that a phone number has voluntarily opted-in to an advertising campaign.

### BRIEF SUMMARY OF THE INVENTION

Disclosed are systems and methods for generating a verified opt-in registry of phone numbers for an SMS marketing campaign. This registry is compiled by obtaining explicit verifications of agreement to receive SMS messages for a specific campaign from individual subscribers. The registry may then be used to audit and verify the campaign by other parties, such as mobile network operators. Explicit verification from each of the mobile numbers in a campaign may be obtained in a variety of ways.

In one embodiment, when a customer uses a cell phone or other device to activate the opt-in form by actuating a CTA, the opt-in form uses the cell phone's messaging application to generate an outgoing opt-in text message to a predetermined phone number. This opt-in text message confirms a customer's consent to receive text messages in a particular campaign and includes an embedded unique identifier for that campaign. The text message may include data such as the date, time, device type, operating system type, a device ID, the mobile carrier, browser type, the specific campaign, the method by which the CTA was actuated (e.g. QR code, banner advertisement, email, SMS text, push notification, etc.). The message may also carry a tracking pixel or unique identifier. The customer must proactively send the message, thereby agreeing to receive text messages from a particular marketing campaign. The phone number, the unique identifier and other information are then recorded in the registry to verify that a particular phone number has explicitly agreed to receive messages relating to a campaign. If an MNO receives a complaint and sends an inquiry regarding a particular phone number, the registry of the systems and methods of the invention may immediately verify that a particular phone number has opted in to a messaging campaign.

In one embodiment, a system for generating a verified opt-in registry for an SMS marketing campaign obtains, for each subscriber, a verification including the subscriber's mobile phone number, a mobile network, a method for requesting the verification, a date on which verification was received, a campaign identifier, and a subscriber identifier. This information is then compiled into a registry of subscriber verification for a marketing campaign.

In one embodiment, a method or a process for generating an SMS (Short Message Service) or IP (Internet Protocol) based messaging unit, from within a single unified campaign platform environment, between internet connected devices through any open or closed content delivery networks, servers, website, or social media sites such that the initiating of a messaging unit may be reported to a third party tracking servers.

One embodiment of the exemplary method and process generates a URL when a mobile user clicks on a call to action, the exemplary method and process automatically populates a message from within a single unified campaign platform on a mobile user's device for delivery on the SMS network or an IP based messaging platform based on a phone number (SMS) or user id (IP based messaging network). The method or process may include the ability to track the entire engagement process through the integration of third party analytics into an ad network platform and a messaging platform.

Certain embodiments of the invention are outlined above in order that the detailed description thereof may be better understood, and in order that the present contributes to the art may be better appreciated. There are, of course, additional embodiments of the invention that will be described below and which will form the subject matter of the claims appended hereto.

It is therefore an object of the present invention to provide systems and methods for quickly and efficiently generating a registry of verified subscribers for an SMS marketing campaign. It is another object of the present invention to provide a registry that may be quickly and easily audited to verify phone numbers in a text messaging campaign, and to provide that verification to a mobile network operator or other party.

It is also an object of the invention to provide DCAs with reliable, verifiable and concrete subscriber data that can be provided to Mobile Network Operators, to reduce the need for the DCA to process Audits, to give the DCAs a strong position regarding compliance with both CSPs and other direct customers, to give the DCAs clear data and quickly resolve campaign suspensions, to help build and restore customer sentiment, and allow the DCAs to focus on building sales with their customers without being bogged down with too complex and difficult campaign decisions.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

It is a further object of the present invention to provide a platform that verifies opt-ins across all major messaging channels associated with subscriber identifiers, including SMS, toll-free, short code, 10DLC, RCS, WhatsApp, and email. By supporting multiple channels in a unified framework, the invention ensures that subscriber consent and campaign compliance can be consistently validated regardless of the medium used to obtain the opt-in.

It is another object of the invention to reduce compliance fragmentation by offering carriers, aggregators, brands, and regulators a single, trusted registry of subscriber-to-campaign verifications across all number-based and identifier-based messaging environments.

In one embodiment, the system establishes a direct one-to-one compliance verification between each subscriber and a specific, carrier-approved messaging campaign. When a subscriber completes an opt-in, the record is stored in association with the unique campaign identifier that corresponds to the campaign registered with mobile carriers and their designated channel partners. This association ensures that every phone number in the registry can be tied not only to an explicit consent event but also to the exact approved campaign for which the consent was granted.

The system further provides the capability for real-time queries by stakeholders in the messaging ecosystem, including mobile network operators, direct connect aggregators (DCAs), brands, and regulators. A query regarding a subscriber's participation in a campaign can immediately return verification that the subscriber has opted in to that specific, carrier-approved campaign. This capability allows the platform to align directly with carrier acceptable use policies and anticipated FCC requirements by making subscriber-to-campaign verification available on demand.

By providing this one-to-one linkage and real-time confirmation, the system enhances transparency, reduces disputes, and protects the integrity of the mobile messaging ecosystem. Carriers and DCAs can rely on the registry to quickly resolve complaints or audits, while brands and regulators gain confidence that each subscriber record is properly validated and associated with the correct campaign authorization.

In another embodiment, the system is configured to obtain and store verified opt-ins not only for SMS messaging campaigns but also for any messaging channel that is based on or associated with a unique subscriber identifier. These channels include, but are not limited to, RCS (Rich Communication Services), WhatsApp or other over-the-top applications linked to a phone number, email addresses used for direct messaging, toll-free messaging programs, short code campaigns, and 10DLC (10-digit long code) campaigns. Each opt-in is captured with the subscriber's identifier and linked to a specific, authorized campaign, enabling the system to provide campaign-level verification across multiple messaging modalities.

This cross-channel capability allows the system to operate as a unified compliance registry for all number-based and identifier-based messaging campaigns, thereby reducing fragmentation in compliance oversight. It further ensures that carriers, DCAs, brands, and regulators can rely on a single verified source to confirm subscriber consent and campaign authorization across multiple communication channels.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an exemplary system flow diagram of an exemplary prior art embodiment of a method for generating an SMS or IP based message in accordance with the principles of the invention;

FIG. 2 is an exemplary system block diagram illustrating various components of a unified campaign platform embodiment in accordance with an exemplary embodiment of the present invention;

FIG. 3 is an exemplary system block diagram illustrating exemplary processes in an exemplary system in accordance with the principles of the invention;

FIG. 3A is a detailed system block diagram illustrating exemplary processes in an exemplary system in accordance with the principles of the invention;

FIG. 4 is an exemplary detailed setup process consistent with an exemplary embodiment in accordance with the principles of the invention;

FIG. 5 is an exemplary Setup flow block diagram consistent with an exemplary flow for the Setup Process in accordance with an exemplary embodiment of the present invention;

FIG. 6 is an exemplary system diagram for the Setup Process illustrating an exemplary architecture of the setup process in accordance with an embodiment of the present invention;

FIG. 7 is an exemplary Campaign File Creation Interface in accordance with an embodiment of the present invention;

FIG. 8 is an exemplary 3rd Party Analytics Dashboard in accordance with an embodiment of the present invention;

FIG. 9 is an exemplary system diagram for an Advertising Network Server in accordance with an exemplary CTA Target URL configuration interface illustrating an exemplary display of a digital ad campaign showing the Target URL in accordance with an embodiment of the present invention;

FIG. 10 is an exemplary system block diagram illustrating an embodiment of the Campaign Publishing architecture in accordance with one embodiment of the present invention;

FIG. 11 is an exemplary flow block diagram of the Campaign Publishing Process in accordance with one embodiment of the present invention;

FIG. 12 is an exemplary system block diagram illustrating the Campaign Interaction Process of the Client Campaign Asset Server in accordance with one embodiment of the present invention;

FIG. 13 is an exemplary Campaign Reporting feature illustrating exemplary code associated with an embeddable tracking pixel and graphical representation of aggregated tracking data obtained from a plurality of embeddable tracking pixels in accordance with one aspect of the present invention;

FIG. 14 is an Exemplary User System Interaction Diagram illustrating exemplary system interactions in accordance with an embodiment of the present invention;

FIG. 15 illustrates an exemplary flow diagram of the User Experience in accordance with an embodiment of the present invention;

FIG. 16 illustrates an exemplary Content Interaction system diagram with an exemplary handheld device in accordance with an embodiment of the present invention;

FIG. 17 is an alternative Content Interaction system diagram with an exemplary handheld device in accordance with an alternative embodiment of the present invention;

FIG. 18 is a process flow diagram of exemplary steps of the Messaging Delivery & Campaign Performance process in accordance with one embodiment of the present invention;

FIG. 19 is an exemplary Messaging Delivery and Campaign Performance network diagram in accordance with an embodiment of the present invention;

FIG. 20 is an exemplary report illustrating the Application Service Provider Messaging Analytics;

FIG. 21 is a diagram of recorded subscriber information stored in a verified opt in subscriber registry in accordance with the principles of the invention;

FIG. 22 is a diagram of a system for creating a verified opt in subscriber registry in accordance with principles of the invention;

FIG. 23 is a diagram for using a push notification to create a verified opt in subscriber registry in accordance with the principles of the invention;

FIG. 24 a flowchart of a method for generating a verified opt-in subscriber registry for a marketing campaign in accordance with the principles of the invention;

FIG. 25 is a flowchart of another method for generating a verified opt-in subscriber registry for a marketing campaign in accordance with the principles of the invention;

FIG. 25 is a flowchart for a repeatable method for verifying subscribers to an advertising campaign.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices may be shown in block diagram form in order to facilitate describing the various embodiments herein.

Various embodiments of the disclosure could also include permutations of the various elements as if each dependent claim was a multiple dependent claim incorporating the limitations of each of the preceding dependent claims as well as the independent claims. Unless explicitly stated otherwise, such permutations are expressly within the scope of this disclosure. Similarly, the disclosure should be interpreted as including permutations of the various elements disclosed in the Figures, unless the various elements are clearly mutually exclusive.

Unless otherwise indicated, all numbers expressing quantities of ingredients, dimensions reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

For ease of understanding, the following definitions will apply throughout this description; however, no definition should be regarded as being superceding any art-accepted understanding of the listed terms.

In an exemplary embodiment, a system of the invention works by initiating the mobile phone owners native IOS or Android messaging application. It pre-loads the opt in message which includes a unique identifier and requires the individual that is opting into the campaign to initiate and send the initial opt-in message. VORTXT then uses our technology to capture the phones ID and identifier, along with other subscription details and store them in the repository.

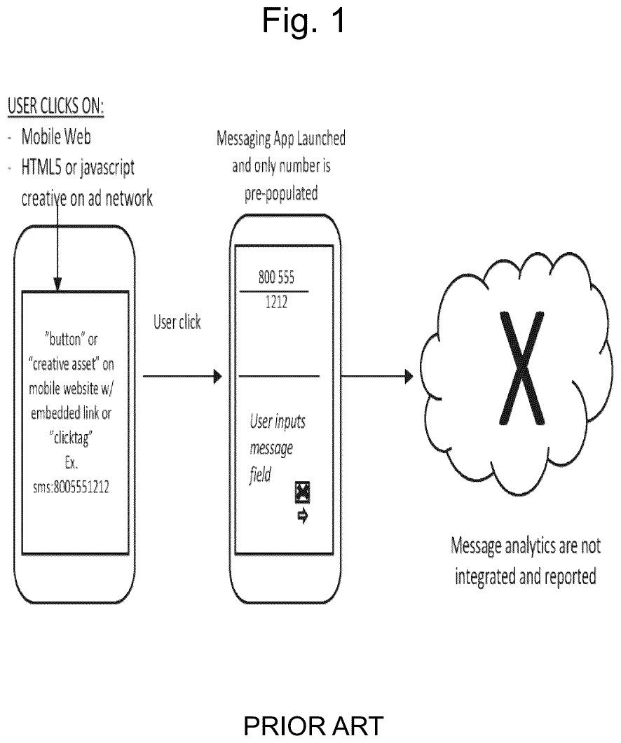

Referring to the drawings in more detail, FIG. 1 shows an exemplary embodiment of the prior art process for manually generating a message from a single device specific environment. This process illustrates devices connected via the internet through a content delivery network which may include, but is not limited to, communications between client-server, server-server, application-server, browser-website server or client app-social media servers. As illustrated, the message is manually generated on a single device using the device input and output requirements for manual transmission from the device to a third-party server, website or social media site through a network. If the third party and the device are configured, tracking and embeddable metadata including statistical and demographic information is separately recorded and selectively transmitted.

FIG. 1 illustrates an exemplary prior art process for generating an SMS or IP based messaging unit, from within a single environment. As illustrated the message is generated directly on the mobile device with the user clicking on a client application. Using current methods, a messaging app may be launched on the device with only a contact number pre-populated. Typical communications occurs between internet connected devices and content delivery networks, servers, websites or social media sites such that the initiation of a message unit may be tracked and reported by a third-party tracking server. As indicated, third party tracking is provided externally and through a separate system instead of providing a means to monitor or track within the same environment. In the exemplary prior art embodiment, HTTP based analytics are not integrated and automatically reported because the CTA URL uses the SMS protocol which is not compatible with standard (HTTP) internet protocol and analytics.

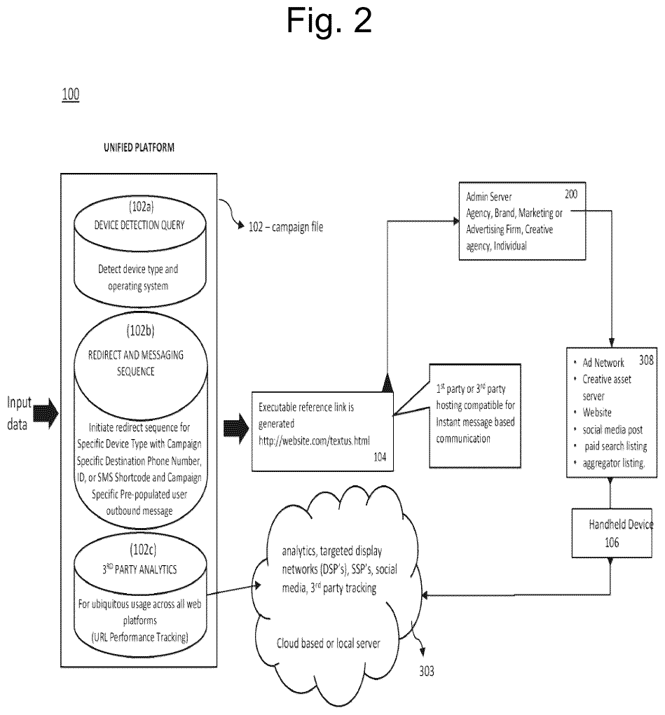

FIG. 2 illustrates an exemplary embodiment of the present invention with a unified campaign platform receiving input data to create a campaign file 102 used by a content server in communication with a unified campaign platform 100 which generates an call to action executable reference link 104 which is transmittable to an Admin Server 200 and then transmitted to the Ad Network 308 for placement and receipt by a Handheld Device 106. Generally, the executable reference link 104 is programmed for instant message based communication. The Admin Server 200 may be affiliated with an advertising based company, i.e. a CSP, and include affiliate data associated with a particular agency, brand, marketing or advertising firm, creative agency or individual. The Ad Network 308 may include a creative asset server, website, social media post, paid search listing and aggregator listing which provides the affiliate data to be associated with the executable reference link. Alternative, the communication may be directed through a remote cloud based server.

The unified campaign platform 100 generally receives input data and processing the input data based on a number of steps which includes a device detection query 102a, a redirect and messaging sequence 102b and a third party analytics reporting process 102c. The device detection step 102a generally takes the input data and uses it to detect the user's mobile device including device type and operating system. The redirect and messaging sequence 102b takes the input data and performs a redirection based upon the received input data which may include, but is not limited to a specific user's mobile device type. The unified campaign platform 100 then reviews the campaign specific input data which may include a campaign specific destination phone number, campaign identification, SMS, short code and campaign specific pre-populated user message data and assembles a campaign file 102. Once the campaign file is assembled, third party tracking information is provided which may be used to monitor analytics including targeted display networks, social media, and third party tracking websites or platforms.

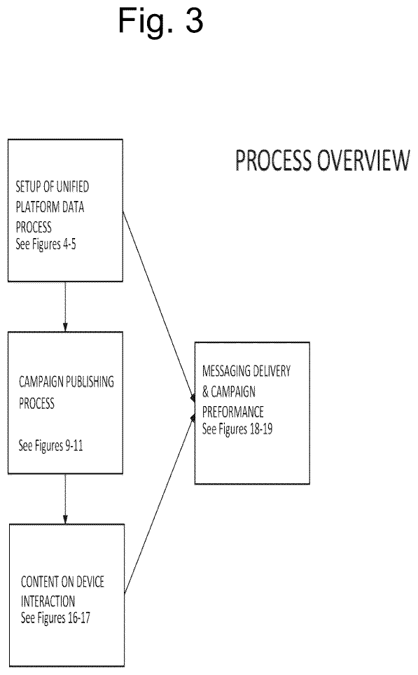

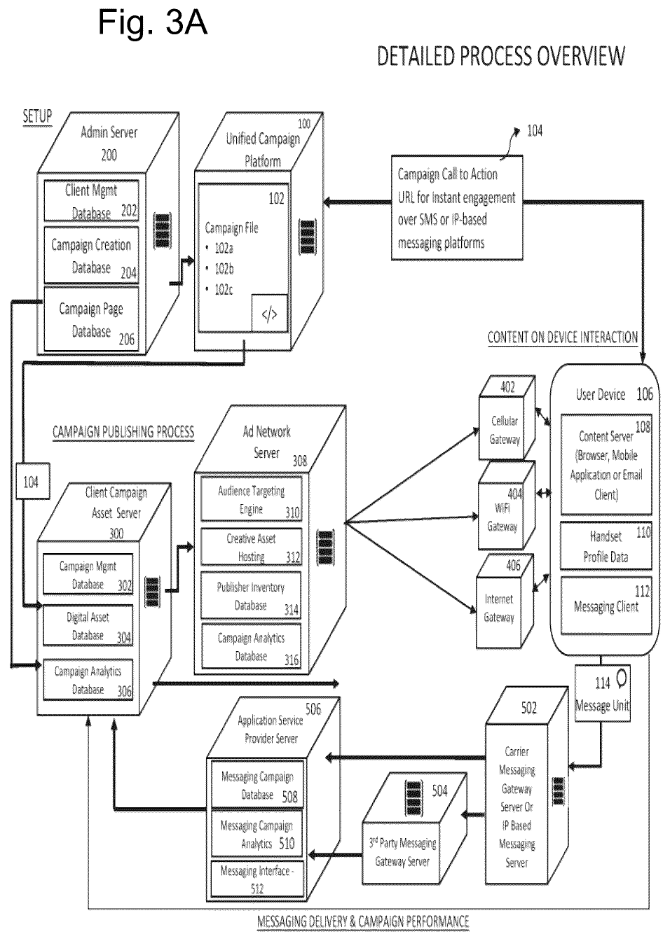

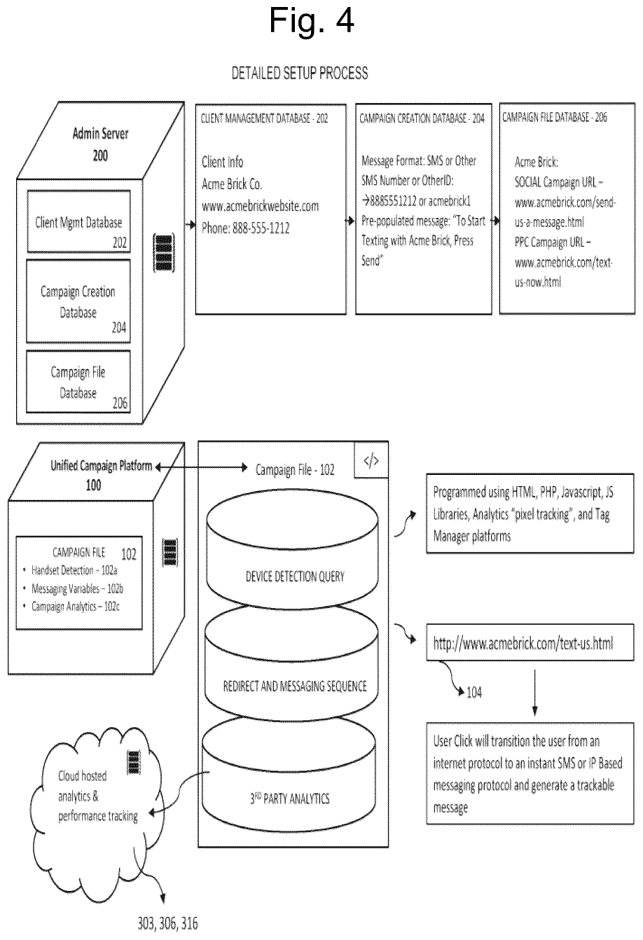

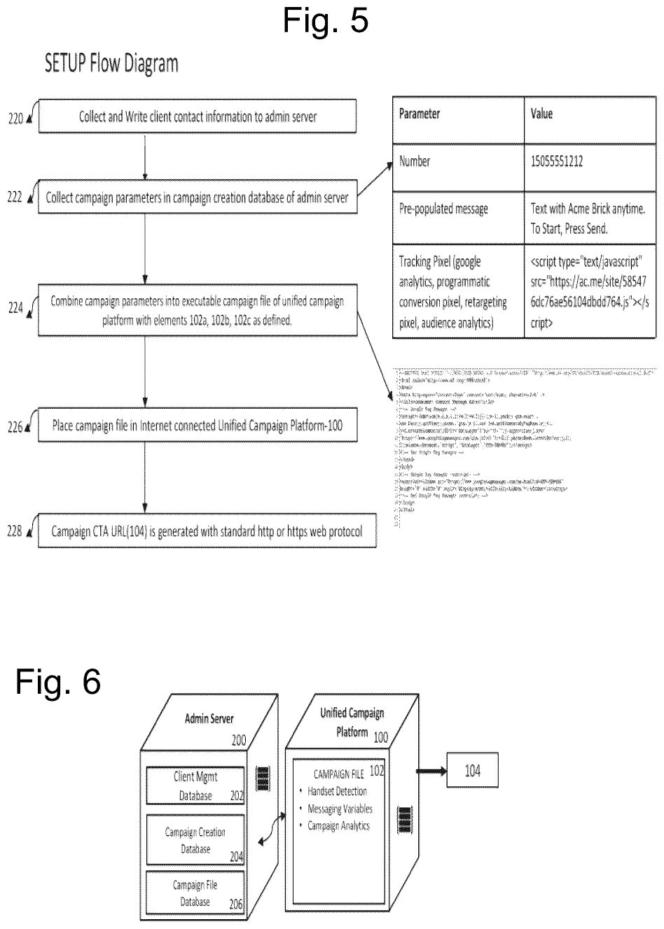

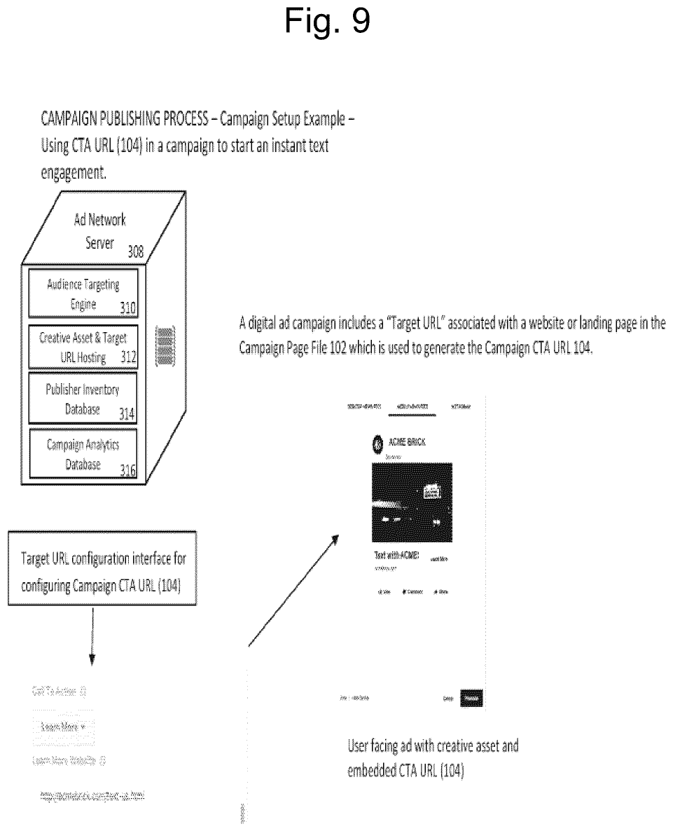

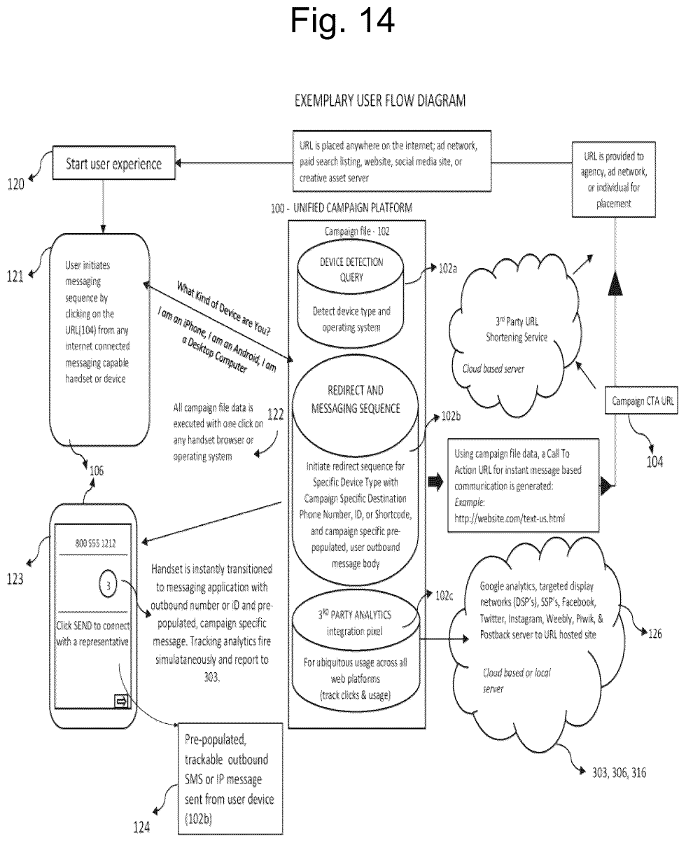

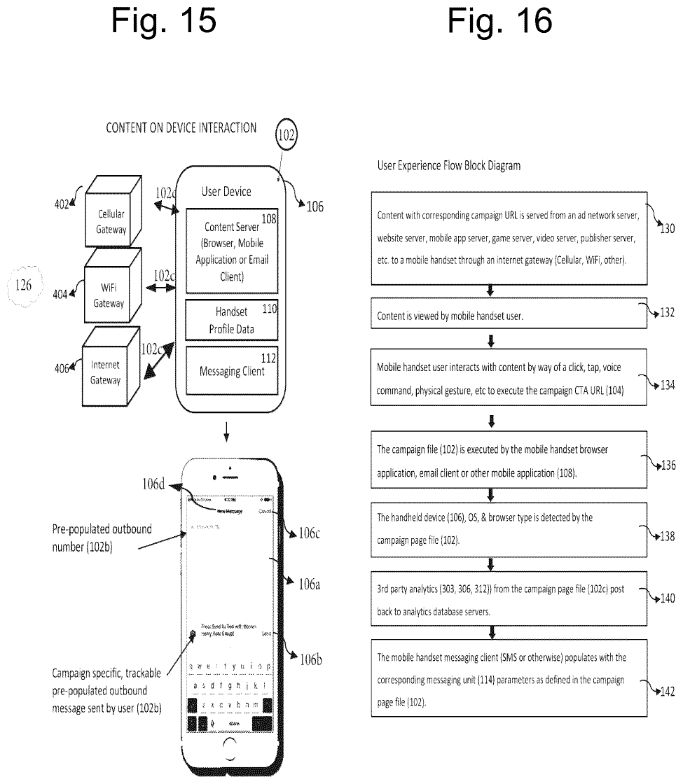

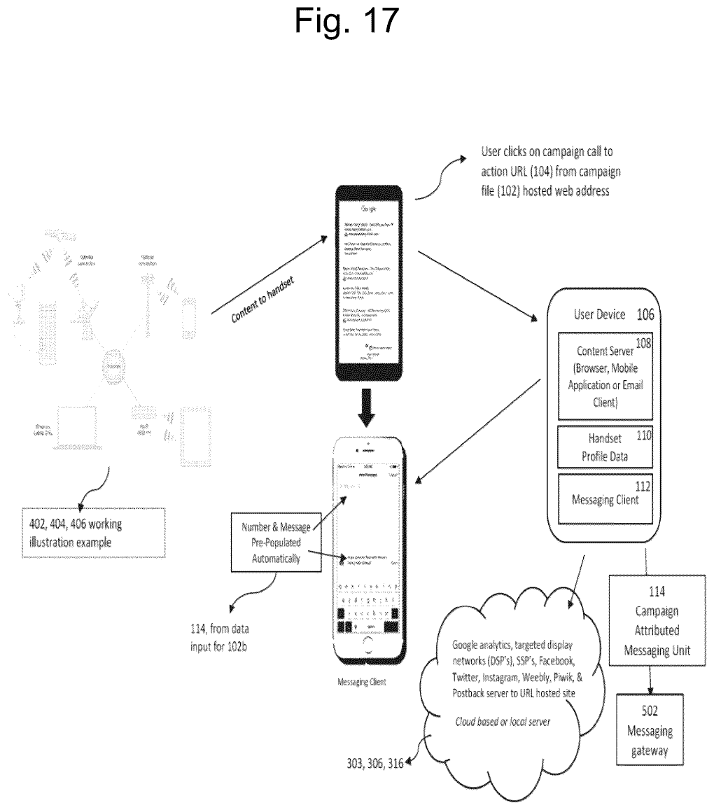

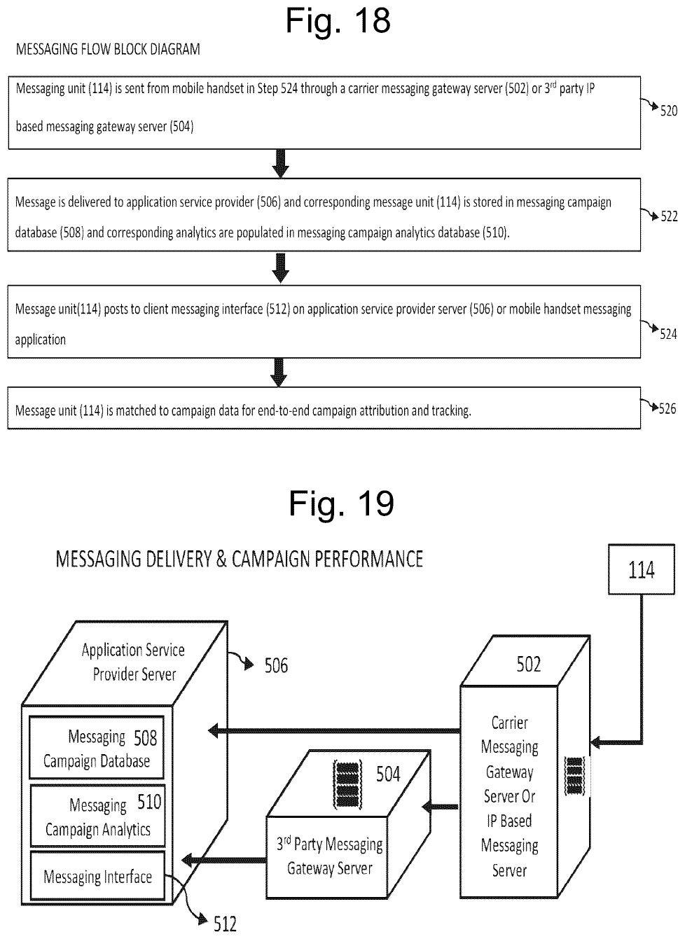

FIG. 3 generally illustrates the overview of the exemplary process where the Unified Campaign Platform Data Setup Process is further illustrated in FIGS. 4-5, Campaign Publishing Process is further illustrated in FIGS. 9-11, an Exemplary User Flow process is illustrated in FIGS. 14-15, an exemplary Content on Device Interaction is illustrated in FIGS. 16-17 and an Exemplary Messaging Delivery and Campaign Performance is illustrated on FIGS. 18 and 19.

FIG. 3A generally illustrates a more detailed system architecture overview for processing exemplary processes including, but not limited to, system configuration, publishing the marketing, for campaign and device interaction and campaign performance.

FIG. 4 illustrates the exemplary Unified Campaign Platform Data Setup process in which the Admin Server 200 generally includes a Client Management Database 202, a Campaign Creation Database 204 and a Campaign File Database 206. In one exemplary embodiment, the Client Management Database 202 may include, but is not limited to, data associated with a particular client such as client information, company information, website information and contact information. In one exemplary embodiment the Campaign Creation Database 204 generally includes information about the particular advertising, marketing or promotional campaign such as, but not limited to, message format, outbound message identification and prepopulated message data. In one exemplary embodiment, the Campaign File Database 206 generally includes information about the company, the call to action server or website to obtain additional information about the particular call to action marketing campaign. Each of these databases may be stored on multiple or at a single location with a single storage or multiple storage media, including remote storage and remote locations. In addition, each of these databases may be created using standard database creation techniques which are generally understood.

Admin Server 200 is generally a hosted storage of administrator client records and campaign parameters and custom text enabled URLs. Client Management Database 202 is generally a repository of data contained on an electronically retrievable storage media with information related to client information such as customer relations management data including, but not limited to, contact information, location information, technical information and website information. Campaign Creation Database 204 is generally a repository of data contained on an electronically retrievable storage media with information related to advertising campaign specific parameters such as an outbound number or ID and prepopulated message content. Campaign File Database 206 is generally a repository of data contained on an electronically retrievable storage media with information related to files stored locally or remotely related to a client and its advertising campaign and which are related to the client, a user or a customer. In the embodiment illustrated in FIG. 6, the Campaign File 102 is linked to the Campaign File Database 206 of the Admin Server 200.

In FIG. 4, Campaign Call to Action URL or Campaign CTA URL 104 is generally an automatically generated URL which indicates the web site address of an executable program for the Campaign File 102. In FIG. 3A, the Unified Campaign Platform 100 is generally an electronic computer system which retrievably stores and generates data for creating the messaging unit 114 for the handheld device 106 and embeddable tracking pixel used to generate tracking analytics for the prepopulated on-device message generated on the handheld device 106 based upon the Campaign File 102.

Generally, the Campaign File 102 contains the prepopulated content data and an embeddable tracking pixel in an executable format for instructing the client web application or internet browser on the internet connected handheld device 106 to obtain data from an internet connected server located remotely associated with the advertising campaign when the Campaign CTA URL 104 is selected. Handset Detection 102a directs the handheld device 106 to obtain the correct version of the Campaign File 102 which is associated with the particular device type and operating system of the handheld device 106. Redirect and Messaging Variables 102b generally execute the desired target client application and provides the campaign specific prepopulated message content and outbound ID for communication between the desired target client application and the handheld device 106. The campaign or third party analytics 102c generally refers to the embeddable digital pixel also referred to as an embeddable tracking pixel which has uniquely identifiable data which allows for tracking and monitoring of the transmission and receipt of the embeddable digital pixel which may be collected for storage and manipulation by a third party remote server with a graphical user interface.

In the embodiment illustrated in FIG. 4, the Unified Campaign Platform 100 includes a campaign file 102 which includes, but is not limited to, handset detection data 102 associated with detecting a handheld device 106, redirect and messaging variables 102b along with analytics data associated with measuring and tracking campaign performance 102c, also referred to herein as campaign analytics. Generally, handset detection data 102a is automatically determined by transmitting a particular query automatically to the handheld device 106 during transmission of the campaign file 102 to the handheld device 106. The query may utilize standard techniques for querying the handheld device 106 including html, php, javascript, js libraries, pixel tracking and tag manager platforms. Generally, the Redirection and Messaging sequence 102b occurs automatically upon the receipt of the call to action campaign URL 104 which provide the address of a website server upon the execution of a “User Click” which initiates communication between the handheld device 106 and the website server which automatically transitions the handheld device 106 from an internet protocol to an instant message or IP based messaging protocol while simultaneously generating a trackable message.

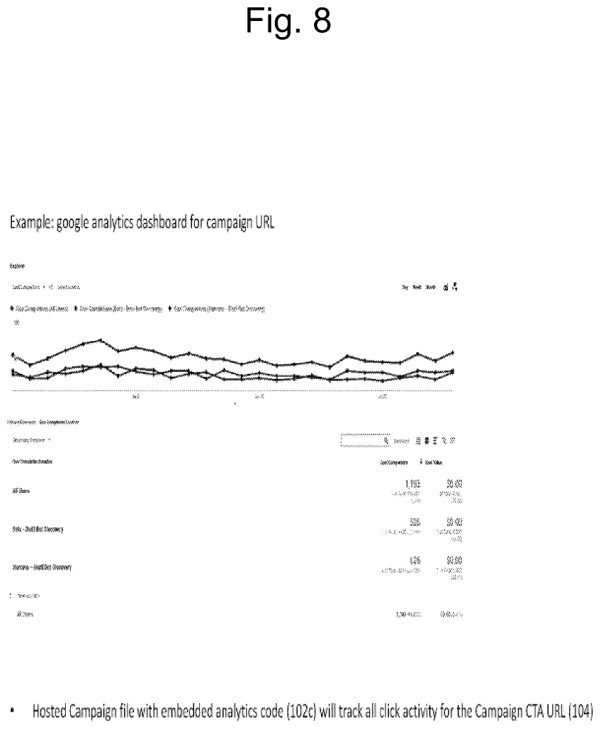

Generally, third party providers facilitate retrievable storage of data associated with the third party analytics tracking data along with measuring and displaying the obtained data. One example of a third party analytical platform is illustrated in FIG. 8 in which google analytics dashboard is utilized for hosting, measuring, displaying and manipulating system generated tracking data associated with the embeddable tracking pixel 102c which may be utilized for monitoring and tracking analytics data associated with the Campaign CTA URL 104.

FIG. 5 illustrates an exemplary flow diagram of the Setup Process in which the Admin Server 200 is configured for the collection and storage of client contact information in step 220, campaign parameters are configured and retrievably stored within the Campaign Creation Database 204 at step 222 which may include a record with, for example, but not as a limitation, a unique identifier, prepopulated message content and code associated with the embeddable tracking pixel, the record associated with a specific advertising campaign. At step 224 campaign parameters may be combined into an executable Campaign File 102 retrievably stored within the Unified Campaign Platform 100 with the handset detection 102a, redirect and messaging variables 102b along with the embeddable tracking pixel 102c. The Campaign File 102 may then be placed within the Unified Campaign Platform 100 at step 226 and the Campaign CTA URL 104 may be generated as a self-executable file and retrievably stored for selective transmission to the appropriate handheld device 106 during the advertising campaign as indicated at step 228.

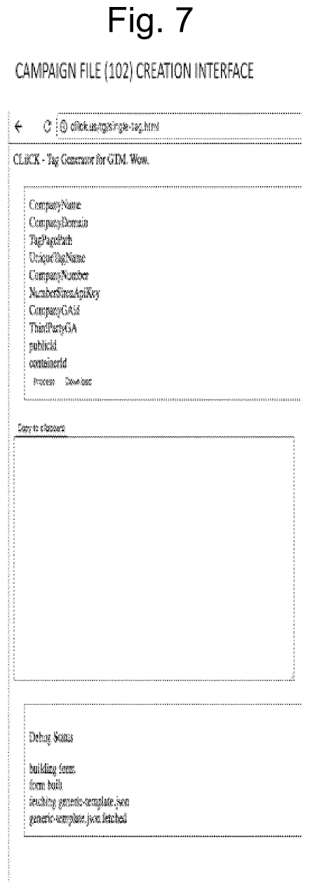

FIG. 6 illustrates an exemplary embodiment of Admin Server 200 in communication with the Unified Campaign Platform 100 for selective transmission of the Campaign CTA URL 104. FIG. 7 illustrates an exemplary instance in which the Campaign File 102 is generated with various desired parameters including, but not limited to, company name, company domain, tag name and location along with other desirable parameters. In this way, the parameters may be customized to allow for simply or complex integration with various advertising platforms.

FIG. 9 illustrates an exemplary Advertising Network Server 308 in association with the Campaign Publishing process. The illustrated Advertising Network Server 308 is configured for direct receipt of communication from the handheld device 106 via the target client application such as, but not as a limitation, a messaging client 112. In the illustrated example, the Campaign CTA URL 104 is utilized to initiate SMS communications between the handheld device 106 and the Advertising Network Server 308. As further illustrated in FIG. 9, the Advertising Network Server 308 includes and Audience Targeting Engine 310, a Creative Asset and Target URL Hosting 312, a Publisher Inventory Database 314 and a Campaign Analytics Database 316. When creating the Advertising Campaign a Target URL is provided which is generally associated with the target of the advertisement such as a client website, landing page or other internet location which contains the desired advertisement. The present system and process allows for use of standard URL architecture to automatically generate a message based communication between the handheld device 106 and the Advertising Network Server 308 upon the selection of the Creative Asset 312.

Generally, the Advertising Network Server 308 is an online advertising network or advertising network server which connects advertisers to website that want to host advertisements and which provide hosted internet content in communication with handheld devices 106 via the internet and which provides and promotes for the marketing of products and services to consumers based upon client content using an hierarchical algorithm to target a desired consumer demographic based upon client provided parameters and which facilitates transmission of the embedded tracking pixel along with the advertising content to the consumer from a remote location. Some Advertising Networks aggregate advertisement from publishers and match it with advertiser demand. Examples of an Advertising Network Server 308 include, but are not limited to, paid search advertisers, publisher networks, display networks, social media networks and first party websites.

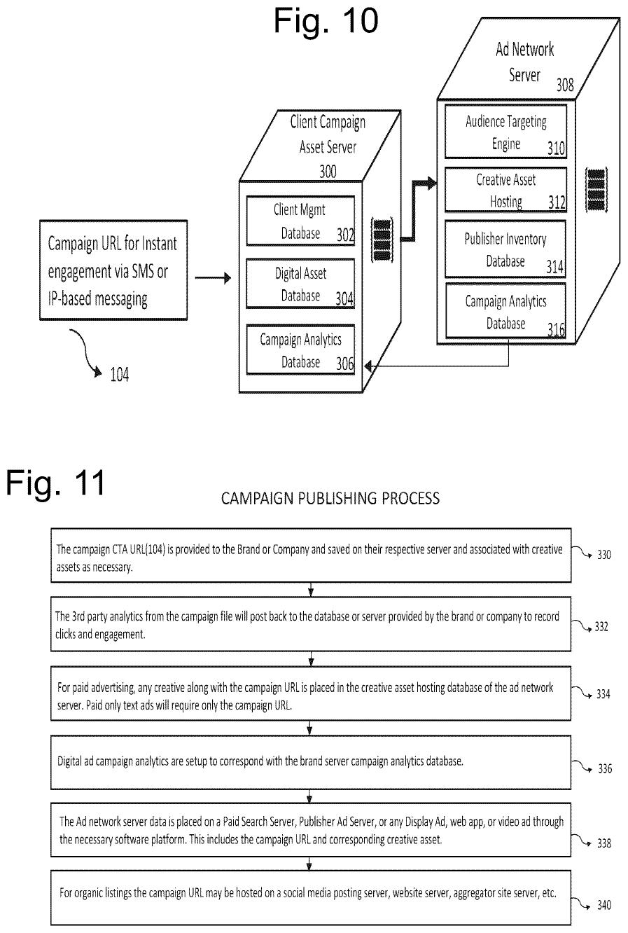

The Advertising Network Server 308 illustrated in FIG. 9, includes an Audience Targeting Engine 310, a Creative Asset Host 312, a Publisher Inventory Database 314 and a Campaign Analytics Database 316. The exemplary Audience Targeting Engine 310 allows for configuration of the target demographics of the prospective audience which may be based upon various social media parameters, pay per click parameters, impression based DSP and targeted websites. Generally, the Creative Asset Host 312 provides the retrievable storage media for hosting the creative asset and the URL which is retrievably stored on an Advertising Network Server 308. Generally, the Publisher Inventory Database 314 provides a repository of data contained on an electronically retrievable storage media with information related to websites and mobile applications which may be used to display creative asset content from a specified advertiser. Generally, the Campaign Analytics Database 316 provides a repository of data contained on an electronically retrievable storage media with information related to embeddable tracking pixels used for monitoring and tracking analytics by the Advertising Network Server 308 which are transmitted in the Campaign File 102 by the Campaign CTA URL 104. FIG. 10 illustrates an exemplary block flow diagram of the Campaign CTA URL 104 which is transmitted to the Client Campaign Server 300 and then to the Advertising Network Server 308 for retrievable storage as part of the Advertising Campaign.

FIG. 11 illustrates an exemplary flow diagram of the Campaign Publishing Process in which step 330 provides for the Campaign CTA URL 104 being transmitted to a client associated with a brand or company for retrievable storage on their server and which can be configured for association with their creative assets as desired. At step 332, tracking data associated with the embeddable tracking pixel from the campaign file 102 is sent from the 3^{rd} party analytics provider is transmitted to the client for retrievable storage. At step 334 the Creative Asset Host 312 retrievably stores paid advertising and creative assets along with the Campaign CTA URL 104. Digital ad campaign analytics on the Campaign Analytics Database 316 of the Client Campaign Asset Server 300 are configured to correspond to the Advertising Network Server Campaign Analytics Database 316 at step 336. At step 338, data associated with the Advertising Network Server 308 is placed on the Paid Search Server, Publisher Ad Server or any Display Ad, web app or video ad through the necessary software platform. This may include the Campaign CTA URL 104 and corresponding creative asset. As indicated at step 340, organic listings may host the Campaign CTA URL 104 on a social media posting server, website server or aggregator site server.

Generally, the Client Asset Server 300 is an online database of interactive digital assets for transmission over the internet from the Client Asset Server 300 to the handheld devices 106 and may include, but is not limited to, brand, agency, publisher and company data. Client Management Database 302 is generally a graphical interface in communication with a repository of data contained on an electronically retrievable storage media with information related to a brand's advertising campaigns where the campaign CTA URL 104 and messaging parameters and reference notes are retrievably stored. This may include, but is not limited to, a locally or remotely hosted spreadsheet, CRM system or customized database. Digital Asset Database 304 generally refers to a repository of advertising data contained on an electronically retrievable storage media with information related to creative advertising asset such as, but not limited to, textual materials, visual images, sound recordings, animated images or video graphic recordings or any combination of any of the above works. Campaign Analytics Database 306 generally refers to a graphical interface with a marketing dashboard, advertising platform, tracking code platform which is accessible locally or remotely which contains the clients' internal digital campaign metrics and performance indicators. The clients' internal digital campaign metrics may include, but is not limited to, various keywords, tags and rankings as indicated on various search engines.

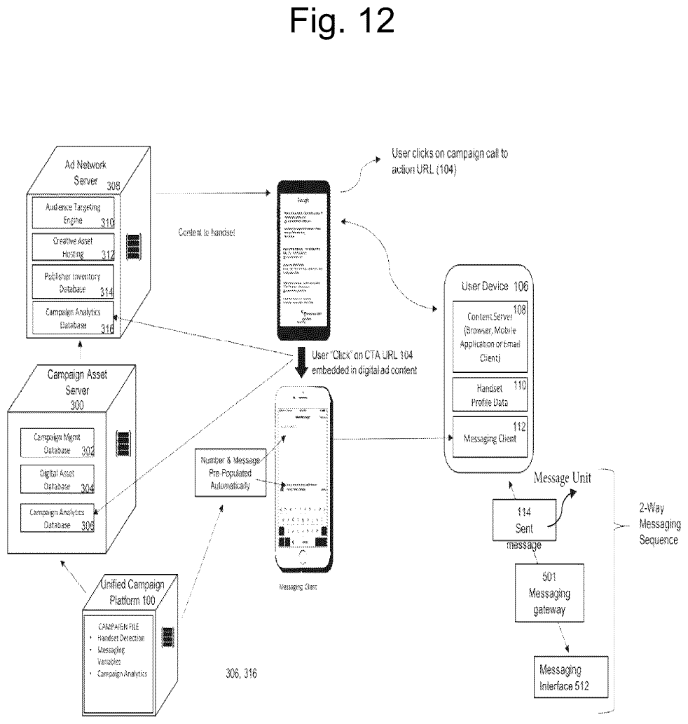

FIG. 12 illustrates an exemplary embodiment of the Campaign Interaction Process with Client Campaign Asset Server 300. As depicted, the Advertising Network Server 308 provides content to the handheld device 106. Once the user selects the Campaign CTA URL 104, the handheld device transmits the embeddable tracking pixel to the Campaign Analytics Database 316 on the Advertising Network Server 308 and the Campaign Analytics Database 306 on the Client Campaign Asset Server 300 and opens the target application on the handheld device 106 such as the messaging client 112 in which the outbound number and message content are prepopulated as provided by the Unified Campaign Platform 100. The messaging client 112 initiates two-way communication through the messaging gateway 501 to the Messaging Interface 512.

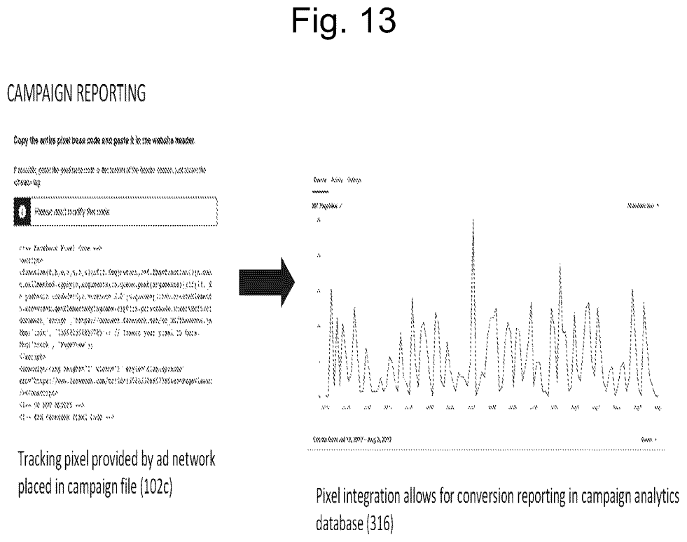

FIG. 13 illustrates an example of code associated with the embeddable tracking pixel 102c, which is aggregated for integration for conversion reporting diagram. The tracking data from the embeddable tracking pixel 102c aggregated within a 3^{rd} party analytics platform illustrating an exemplary graphic used in monitoring, tracking and manipulating the tracking data associated with the embeddable tracking pixel 102c.

FIG. 14 illustrates an exemplary user flow diagram of the exemplary system in which a handheld device 106 is in communication with the Unified Campaign Platform 100 content server for communication between the handheld device 106 and a remote url. In FIG. 15, the user experience is initiated in step 130 upon receipt of a url which is placed online in association with the internet such as an ad network, paid search listing, website, social media site or creative asset server. Once the user views content 132, the user initiates the messaging sequence in step 134 by clicking on the url from any internet connected messaging capable handset or device 106 such as, but not limited to, a smartphone, tablet or pc based device. Depending on the particular device, the system determines the device type and the redirect and messaging sequence 102b of the unified campaign platform 100 initiates the redirect sequence for the specific device type. The redirect sequence 102b generally transmits data associated with a campaign file for execution by software associated with the handset such as a computer browser or computer operating system. Exemplary campaign data may include textual and numerical data including information related to the handheld device type along with a phone number or TCP-IP address associated with the handheld device 106, a user or handheld device identification, an abbreviated short code along with campaign specific prepopulated data such as outbound user data and outbound message data.

Tracking data may also be provided in the form of a beacon or other embeddable data which can be used to track and analyze information about the receipt and transmission of advertising campaign data received by the handheld device 106 and transmitted from the handheld device 106. Generally, the system may associate the embeddable tracking pixel 102c such as, but not limited to, a tracking beacon with a specific campaign for ubiquitous usage of the campaign file 102 across all web platforms. Generally, the integrated pixel is essentially a network call to a remote tracking server, which tracks clicks and usage data which can be associated with the campaign file 102 which has not been transmitted, is in the middle of transmission, or has been transmitted to the handheld device 106.

The tracking server (not shown) may be the same as the Admin Server 200, client campaign asset server 300 or ad network server 308, or it may be a different server. The data recorded by the tracking server may be provided later to the Ad Network Server 308 through the 3^{rd} party analytics 102c as verification that the campaign file 102 was transmitted and received, while providing information about what or which handheld device 106 received the campaign file 102 or transmitted the automatically generated message unit 114.

As further illustrated in FIG. 14, the user may perform an action, such as a click, at step 122 through the user interface of the handheld device 106 or a remote server may redirect the handheld device 106 and automatically launch the handheld device's messaging client 112 based upon the campaign file 102 with embeddable campaign specific data such as a URL or SMS associated with an advertiser allowing for the transmission of the specified message with the prepopulated data, including outbound message id and messaging content, through the handheld device's messaging app. The behavior of a client messaging app or other target application during user interaction may be controlled with the campaign specific prepopulated data.

Generally, upon receipt of the campaign file 102 with campaign file data, the handheld device 106 launches the messaging client 112 which is prepopulated with campaign specific data including outbound data associated with a particular phone number or IP address and prepopulated message data and campaign specific message content. In addition, the embeddable tracking pixel 102 c or tracking beacon may be utilized simultaneously to transmit tracking data to the tracking server at the same time that the messaging client 112 is launched.

Prior to launching the messaging client 112, or other target application, the campaign file 102 may prompt the handheld device 106 to display a confirmation message to confirm the app has permission to proceed. Alternatively or additionally, as indicated in step 123, prior to transmitting the messaging unit 114, which is prepopulated with messaging content, the handheld device 106 may display the prepopulated message, automatically populated with the specific prepopulated data along with the user outbound message content, prompting the handheld device 106 for a “SEND” command. Upon completion, the messaging client 112 may close with the handheld device 106 returning to a normal condition.

Upon transmission of the embeddable tracking pixel 102 c to the tracking server, data may be collected for use with a third party analytics platform such as, but not limited to, Google analytics, targeted display networks (DSP's), SSP's, Facebook®, Twitter®, Instagram®, Weebly®, Piwik & Postback® server to URL hosted site.

An exemplary user experience flow block diagram is illustrated in FIG. 14, in which the handheld device 106 receives content from a corresponding campaign CTA URL 104 which is transmitted to the handheld device 106 from, for example, the Ad Network Server 308, which may include, but is not limited to, a Website Server (not shown), Mobile App Server (not shown), Game Server (not shown), Video Server (not shown), Publishing Server (not shown), Social Media Server (not shown) through the gateway server which may include one or more of the Internet Gateway 406, the WiFi Gateway 404 or the Cellular Gateway 402, for example.

As illustrated at step 132, the transmitted content may be displayed on the handheld device 106. Generally, the transmitted content may relate to a advertising campaign URL which may be transmitted as part of a mobile website, social media website, game application, gaming website, video, article or display ad. Execution of the call to action executable reference link also referred to as the campaign CTA URL 104 may be preformed by the handheld device 106 with for example a click, tap, voice command, physical gesture as indicated in step 134.

Once the campaign CTA URL 104 is preformed, the campaign file 102 automatically engages with the target application, like the messaging client 112 as indicated in step 136. The campaign file 102 inspects the handset profile data and detects the handheld device type, operating system and client internet browser as indicated in step 138 and simultaneously transmits handset profile data back to the Client Campaign Asset Server 300 and tracking data to the third party analytics database servers associated with the third party analytics platform as indicated in step 140.

Once the handset profile data and third party analytics data are transmitted, the handheld device 106 launches the target application 108 (also referred to herein as content server) as determined by the call to action executable reference link 104 which interfaces between the campaign files 102 on the Client Campaign Asset Server 300 and the handheld device 106. As further illustrated at step 142 and based in part upon the received campaign file 102, the handheld device 106 target application 108 is launched. In addition, a window associated with the Messaging Client 112 is displayed and prepopulated with the corresponding messaging data 114 and associated campaign data and other campaign file messaging unit parameters as provided by the campaign page file 102.

As illustrated in FIG. 16 the campaign page file 102 may be transmitted to the handheld device 106 simultaneously while tracking data 102 c is transmitted to the third party analytics platform 126 via the Cellular Gateway 402, the WiFi Gateway 404, the Internet Gateway 406. Generally, the handheld device 106 includes a target content server application 108 also referred to herein as a target application or messaging client, may include a number of client applications like an internet browser, an email client or another mobile application for operation on a typical handheld device 106.

The exemplary handheld device 106 in use with the present invention also includes data associated with the handset profile data 110 and a messaging client 112 software program or application. A typical handheld device 106a displaying the prepopulated target app, a messaging client which contains the automatically generated prepopulated outbound number and campaign specific, trackable prepopulated outbound message. The “New Message” window 106d is displayed prior to transmission for approval and confirmation via the “Send” command 106b or rejection via the “Cancel” command 106c, both of which are displayed in the display window illustrated on the exemplary handheld device 106a.

The gateway server generally refers to any one of data transmitters which provide connectivity to the internet by a handheld device carrier and/or carrier handset such as the Cellular Gateway 402, WiFi Gateway 404, Internet Gateway 406 or other gateways which provide access to the internet for a mobile or wireless device. Generally a wireless device refers to a handheld device with internet connectivity and may include a device with handset profile data 110, which generally refers to data which is sent to the Client Campaign Asset Server 300 which retrievably stores device identifying data associated with the handheld device 106 in the campaign page files 104.

FIG. 17 illustrates an alternative embodiment of the Content on Device Interaction in which content is provided to the handheld device 106 through a series of data communication devices for selective engagement of the target Messaging Client 112 application which automatically prepopulates the New Message window with message content along with an outbound number for sending the message.

As further illustrated in the alternative embodiment of FIG. 17, the Campaign Attributed Messaging Unit or messaging unit 114 is sent from the handheld device 106 to the Messaging Gateway 501. FIGS. 18-19 illustrate an exemplary block flow diagram and system architecture diagram for the alternative embodiment of FIG. 17. At step 520, the Messaging Unit 114 is transmitted from the handheld device 106 through the messaging gateway server 502 to the Application Service Provider 506. Alternatively, the Messaging Unit 114 may be transmitted from an IP based Messaging Server 502 to a 3^{rd} party Messaging Gateway Server 504 to the Application Service Provider Server 506. Once the Message is transmitted to the Application Service Provider Server 506, at step 522, the corresponding Message Unit 114 is retrievably stored in the Messaging Campaign Database 508 along with the corresponding analytics which are populated in the Messaging Campaign Analytics Database 510. At step 524, the Messaging Unit 114 is transmitted to the Client Messaging Interface 512 on the Application Service Provider Server 506 or the handheld device 106 messaging application. Then the Messaging Unit 114 is matched to campaign data for end-to-end campaign attribution and tracking.

As used in FIGS. 18-19, the Carrier Messaging Gateway Server 502 refers to the process in which the SMS/MMS/Carrier or Native message is routed through a carrier gateway. 3^{rd} Party Messaging Gateway 504 generally refers to IP based messaging gateway servers. Generally, the Application Service Provider Server 508 includes the Messaging Campaign Database 508, the Messaging Campaign Analytics 510, the Client Messaging Interface 512 and the transmitted Messaging Unit 114. The Messaging Campaign Database 508 generally refers to a repository of data contained on an electronically retrievable storage media with information related to interactions hosted by the Application Service Provider Server 506. The Messaging Campaign Analytics 510 generally refers to any reporting based upon the aggregation of tracking data from the embeddable tracking pixels 102c. Client Messaging Interface 512 generally refers to any peer to peer or automated response messaging interface provided by the Application Service Provider Server 506 to any brand, agency or reseller. Messaging Unit 114 refers to the specific prepopulated message which provides for post-click tracking and attribution.

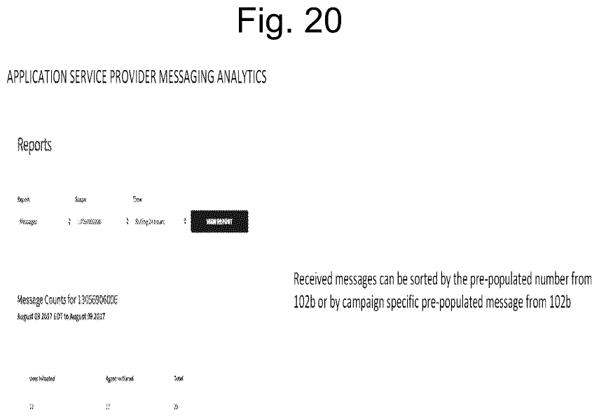

FIG. 20 illustrates an exemplary Application Service Provider Messaging Analytics report depicting the received messages which can be sorted by the prepopulated number from Redirect and Messaging Sequence 102b.

According to some embodiments of the present invention, the method is implemented as a computer program, namely, as a set of steps or a system utilizing any acceptable computer based platform. Thus, for example, the method may be a cross-platform java application, a standalone application written in native code, a distinct process built into a server, or part of an application server accessible across the internet using a handheld device or a web browser. One of ordinary skill in the art will appreciate that the steps or processes of the present invention are capable of being distributed in the form of a computer readable medium or using multiple processors on a single or multiple computers connected directly or separated by distance and that the present invention applies equally regardless. Such changes and modifications are to be understood as being included within the scope of embodiments of this invention as defined by any claims or a further non-provisional application.

The above embodiments show how the invention may be used to perform a variety of analytics by tracking messaging information. The invention may also be utilized in a more simple manner to generate a registry for a campaign that includes information sufficient to perform an audit when a part of the campaign is flagged. The CTA operates in essentially the same way. When a CTA is actuated, the campaign URL queries the device through which the CTA was engaged. The results of these queries are incorporated into the SMS message. When the message is sent, the data stored in the SMS message is recorded in a secure campaign registry. This registry is then readily available to the brands and their CSPs if an audit is requested. Instead of a campaign being put on hold indefinitely, a subscriber's opt-in can be confirmed in a matter of minutes.

To create an opt-in registry, a CTA with an embedded URL is created, as explained above. The CTA may be an online advertisements, a button in an email, a QR code a push notification or any other electronic messaging object that causes an electronic device to connect to a campaign platform on which the campaign executable program resides. The call to action may be intended for new subscribers or may optionally be sent to existing subscribers in order to generate an opt in registry for a pre-existing campaign. The executable program, as explained above, performs queries on the device to ascertain one or more of the devices phone number, mobile carrier, IP address, device ID, device type, browser type, SMS messaging software type, and the time at which the call to action is activated. The executable program then generates outbound message content that includes the responses to its queries and other campaign related data stored on the campaign platform. The message content is then combined with the outbound ID to create a campaign file that is configured for the device type, operating system, and messaging software type. The outbound ID may be a phone number, email address, or other location accessible using an SMS application or IP messaging application found on the device which activated the campaign platform through the CTA. This campaign file is then transmitted to the device. Upon receiving the campaign file, the device generates a prepopulated message that includes the message content and the outbound ID.

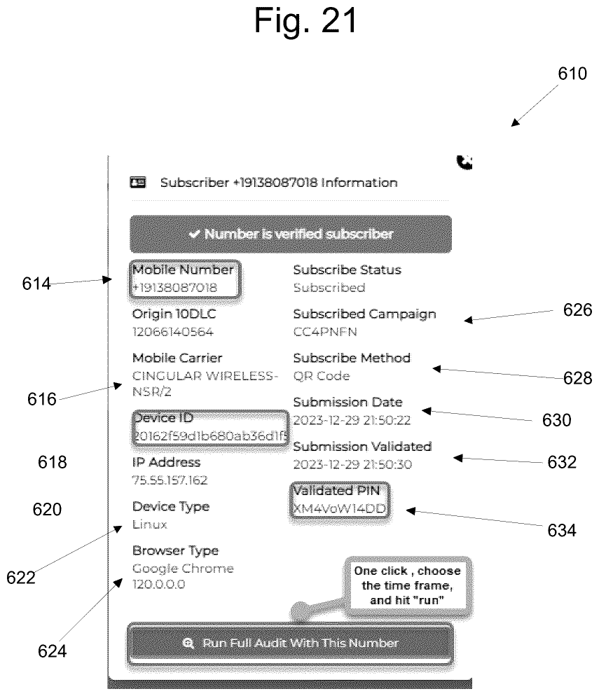

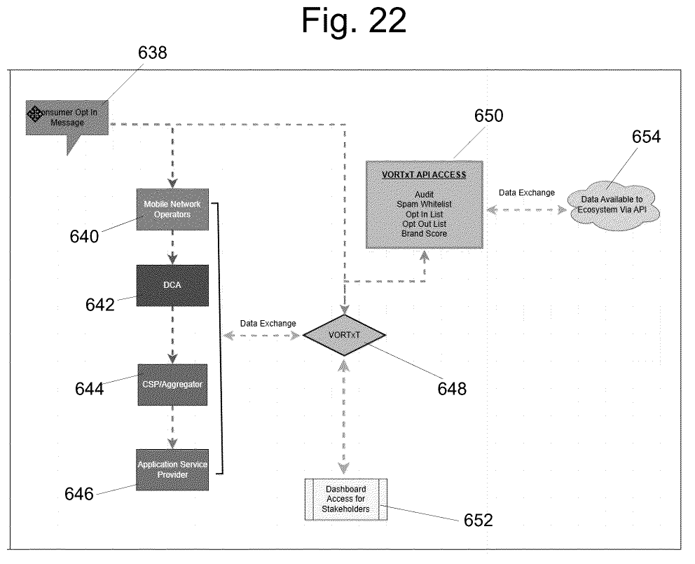

When the prospective subscriber enters the confirmation command, e.g. sends the prepopulated message, it is received at the client messaging interface designated by the outbound ID. The interface then generates a unique validation number for the message sent to it. The message content, the validation number (a/k/a PIN number), and time of receipt of the message are all then recorded in an opt-in registry of verified subscribers. These subscribers are then included with the other campaign information and registered with TCR. Should any of the messages be flagged by a subscriber and an audit initiated, the CSP or brand accesses the information on the opt-in registry to verify that the flagged message was authorized by the subscriber. An exemplary opt-in registry subscriber record 610 is shown in FIG. 21. In this embodiment of the invention, the campaign platform queried the subscribers device to obtain the mobile number, 614, mobile carrier 616, device ID 618, IP address 620, device type 622, and browser type 624. The executable program at the campaign platform included this information in the message content, and also added campaign information including the subscribed campaign 626, the type of CTA activated by the subscriber 628, and the date on which the subscriber sent the outgoing message 630. The registrar, via the client messaging interface, has used this information to create a verified subscriber's record in the registry, and also added to the record the date the submission was validated 632, and a validation number (a/k/a PIN) 634. The validation number 634 is generated by the registrar and is unique to each subscriber.

FIG. 22 illustrates how information is shared upon receiving the opt-in message 638. The message 638 necessarily goes through the MNO 640 and may then be shared with the DCA 642, CSP/Aggregator 644, and the ASP 646. The message is also sent, via the outbound ID, directly to the registrar 648. The registrar maintains the registry 650, which it may make accessible to interested and authorized parties 652. The data in the registry may also be accessible through an API 654.

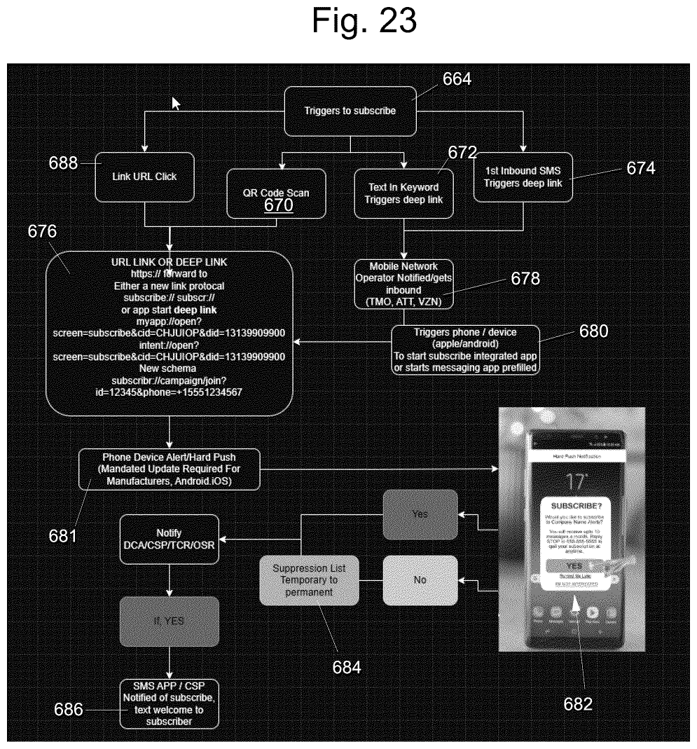

FIG. 23 illustrates another method 660 of sending a prepopulated message 662. First, the new subscriber 664 activates a CTA which may be, for example, a URL link 668 (which may include opening an application), a QR code 670, using a keyword that triggers a deep link 672, or receives an inbound SMS 674 or other message. If a link or AR code is used, the campaign platform is accessed 676 via the link. If a keyword or inbound text is used, the MNO may receive a notice 678 that triggers an application 680 preloaded on the device, which then accesses the campaign platform 676. This preloaded application then generates 681 a prepopulated message in the form of a push notification 682. The push notification 682 explains to a prospective subscriber the nature of the subscription and provides an opportunity to accept or reject the subscription. If the operator of the device activates the “No” CTA, the device will be placed on a suppression list 684. If the operator activates the “Yes” CTA, then the CSP, DCA or other manager of the ad campaign will be notified, and the push notification 682 will be forwarded to a registrar to be included in the opt-in registry. The new subscriber may also receive a welcome message 686. The opt-in registry of verified subscribers may be maintained by a registrar, which may be an entity separate from the CSPs, DCAs, brands, carriers.

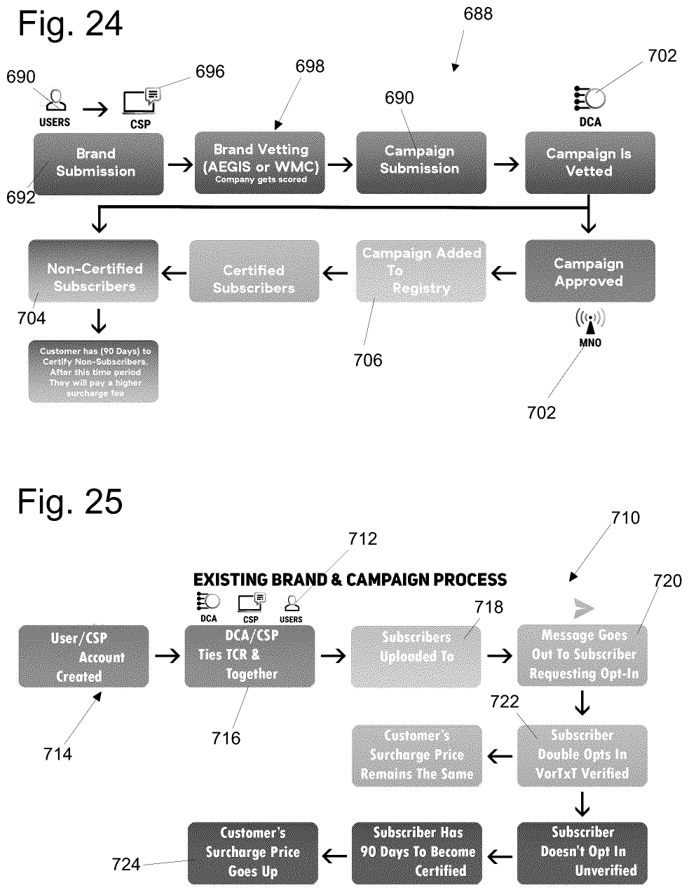

Another exemplary process for generating the registry, shown in FIG. 24, includes system 688 for incorporating a verified opt-in Registry in accordance with the principles of the invention into an existing SMS campaign 690. In the first step 692, a user 690, i.e. a company that wishes to conduct an SMS marketing campaign, uses a CSP 696 to generate the campaign 690. The CSP 696 then vets the campaign in step 698 using any of a variety of third-party sources. Once the user's campaign 690 is vetted, it is submitted to and vetted by a DCA 700, which then submits the campaign to an MNO 702.

Once the campaign 690 is ready to be submitted to an MNO 702, it may also be submitted to an operator of a verified opt-in Registry. In step 704, any mobile numbers that have not been previously verified and included in the verified opt-in Registry are sent an SMS message, notification, email or other electronic object containing a CTA of the invention for collecting information to be included in an opt-in registry. Optionally, the message sent to the subscriber may include some of the information associated with that subscriber which is automatically transmitted to the opt-in Registry once the subscriber follows the link. The system 688 may provide a predetermined time period in which a non-certified subscriber may be added to the opt-in registry.

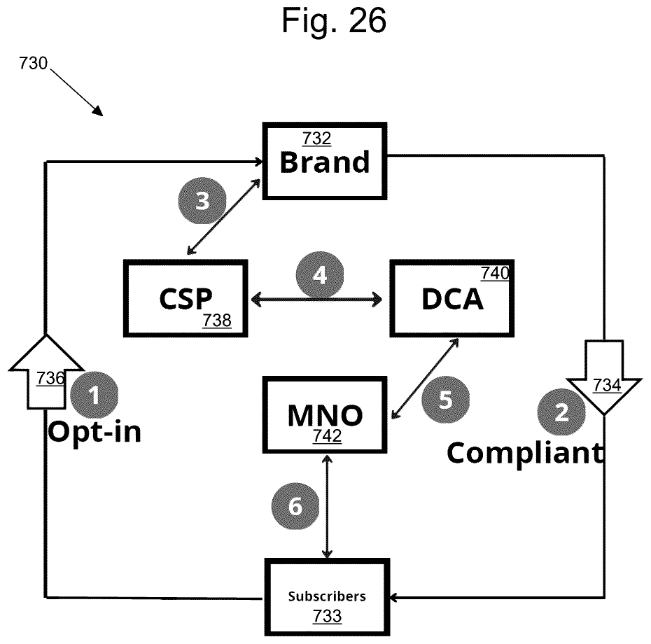

FIG. 25 shows a system for creating a registry of verified subscribers 710 for a pre-existing marketing campaign. A user 712 creates an account with a an opt-in registrar 714 for an existing advertising campaign, and ties it to the campaign registered at TCR, and/or a DCA or SCP 716. The subscribers are uploaded 718 to the account. Messages with the campaign CTA are sent to the subscribers in step 720. If the subscriber opts in using the CTA in step 722, he or she is added to the verified opt-in registry. Subscribers can be incentivized to opt-in by notifying the subscribers that if they do not opt-in, a surcharge will be added to their account 724.

Optionally, users, such as brands or CSPs, may create an account with the opt-in registrar that allows them to select which queries are sent to a device upon CTA activation, and may also optinally select the campaign information to be included in the message content. The user may also create online advertisements, QR codes, hyperlinks or other advertising materials with an embedded CTA for dissemination to prospective subscribers using the account created with the opt-in registrar. When a person scans a QR code, clicks on an advertisement or follows a hyperlink created through the platform, the subscriber identifying information is recorded and automatically loaded into a verified opt-in Registry for the campaign. This may streamline any vetting processes performed by a CSP or DCA prior to submitting the campaign to an MNO. Optionally, a user may use a combination of these two methods, both advertising materials with embedded information and more direct outgoing SMS messages for listed subscribers.

FIG. 26 shows an exemplary system 730 of the invention. When a Brand 732 wishes to verify subscribers, it sends unverified subscribers a verification request that includes a CTA 734 of the invention. For any subscriber 733 who has not been verified, a text or other message requesting verification 736 is sent to the subscriber to confirm his or her opt in status. If the subscriber opt in 736, he or she is added to the opt-in verified registry. Verifications messages 734 may also optionally be sent to all subscribers, further confirming verification of subscribers who are already verified. Once the opt-in status of all the subscribers in a campaign are verified, the Brand 732 notifies the CSP 738. The CSP in turn notifies a DCA 740 who notifies the MNO 742. This system brands engage more subscribers and grow at scale, and saves time and money with subscriber verification.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. That is, the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. The descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A method for generating an opt-in registry of verified subscribers to an SMS marketing campaign comprising the steps of:
a) providing a campaign call to action URL embedded in an electronic messaging object;
b) providing a unified campaign platform at the campaign call to action URL, the unified campaign platform comprising an executable program;
c) mobile device with an SMS application or an IP messaging application activating the unified campaign platform through the campaign call to action URL;
d) the unified campaign platform obtaining device information by performing queries on the mobile device;
e) the executable program of the unified campaign platform creating a campaign file at said unified campaign platform, the campaign file including message content and an outbound ID, wherein the campaign file is configured for the device type, and the message content includes responses to the queries on the mobile device;
f) transmitting the campaign file to the mobile device;
g) the SMS application or IP messaging application of the mobile device creating a prepopulated message comprising the message content and the outbound ID;
h) upon receipt of a confirmation command, the SMS application or IP messaging application sending the prepopulated message to a client messaging interface; and,
i) upon receiving the prepopulated message, client messaging interface generates a validation number and records the validation number, the time at which the prepopulated message was received, and the message content in an opt-in registry of verified subscribers.
